(19) United States
(12) Patent Application Publication
(10) Pub. No.: US 2006/0090621 A1
(43) Pub. Date: May 4, 2006

(54) Paper cutter

(76) Inventor: Fumio Shimizu, Tokyo (JP)

Correspondence Address: Michael S. Leonard;Everest Intellectual Property Law Group, P.O. Box 708, Northbrook, IL, 60065, US

(21) Appl. No.: 11/264,461

(22) Filed: Nov. 1, 2005

(30) Foreign Application Priority Data
Nov. 2, 2004 (JP) 2004-318925

(51) Int. Cl. B26D 1/06

(52) U.S. Cl. 83/455; 83/614

(57) ABSTRACT

A paper cutter, wherein an interlocking member which moves up and down with always maintaining a condition parallel to a base plate is disposed between a paper pressing plate and a rail; linking pins are inserted into second guide holes formed in cam members of the interlocking member and first guide holes formed in supporting bodies so as to support both ends of the rail with the linking pins; by moving the interlocking member to a right-and-left direction by rotating holding means which supports the interlocking member rotatably on the supporting body; and the rail and the paper pressing plate supported to the rail via a paper pressing spring are moved up and down.

### BACKGROUND OF THE INVENTION

1. Field of the Invention

The invention relates to a paper cutter which cuts papers placed at a constant position on a base plate and more particularly to a paper cutter capable of holding papers securely in a stable condition on the base plate and maintaining the holding condition.

2. Description of the Related Art

A conventionally used paper cutter is provided with a paper pressing plate which is supported on the base plate and capable of moving in a vertical direction, papers placed at the constant position on the base plate are held with pressure by the paper pressing plate, and the papers are cut with a rotating blade mounted on a slider by moving the slider along the paper pressing plate.

As a conventionally used paper cutter having the paper pressing plate capable of moving in the vertical direction, a paper cutter, for example, described in Japanese Patent No. 3113949 (patent document 1), which has been proposed by the same applicant of this application has been well known. In a paper pressing unit of the paper cutter disclosed in the patent document 1 shown in FIG. 17, both ends of a rail 52 are constructed to be capable of moving vertically by a pair of supporting members 54 fixed on a base plate 51. FIG. 17 does not show the other supporting member 54.

Below a rail 52, a paper pressing plate 55 is disposed independently of a rail 52, so that the paper pressing plate 55 is provided such that it may move vertically in a perpendicular direction to the base plate 51. Further, a slider (not shown) is mounted on the rail 52 and a rotary blade is mounted on the slider. A guide hole 57 is formed in each of a pair of supporting members 54 which support both ends of the rail 52 as shown in FIG. 18, so that the rail 52 ascends/descends via a pin P2 (see FIG. 17) inserted into the guide hole 57 and the rail 52.

One of the supporting members 54 is constituted of a movable member 61 and a fixed member 62. As for the movable member 61, a tongue piece 64 is provided integrally substantially at a right angle to a lid plate 63 and the tongue piece 64 is fixed to the fixing member 62 such that it is capable of pivoting via the pin P1. The rail 52 and the movable member 61 are connected with pins P2 and P3 via a linking member 58 (linking mechanism).

The fixing member 62 has a gate shape, in which two side plates 65 are integrated by a ceiling plate 66, and is fixed to the base plate 51. The guide hole 57 is formed in each of the side plate 65, the guide hole 57 tilting with a fall of H and having horizontal portions (holding means) extending along the base plate 51.

The paper pressing plate 55 is provided on the base plate 51 independently of the rail 52 and always pressed toward the rail 52 by a compression spring 59 (urging means). Further, the paper pressing plate 55 is pressed perpendicularly with respect to the base plate 51 by a pressing pin 56 provided on the rail 52. Fixing of the position of the paper pressing plate 55 is carried out by guide members 60 fixed to the paper pressing plate 55 such that they sandwich the rail 52.

If the movable member 61 is rotated clockwise around the pin P1 from a condition of (I) to a condition of (II), the pin P2 provided at a front end of the rail 52 moves along the guide hole 57 via the linking member 58. At this time, the rail 52 moves to the right direction in FIG. 17 while maintaining a parallel condition with the base plate 51, rising along the guide hole 57.

When the rail 52 rises, the paper pressing plate 55 rises in a vertical direction by an urging force of the compression spring 59, guided by the guide member 60 until a stopper member (not shown) makes contact with the rail 52. As a consequence, a parallel gap is formed between the paper pressing plate 55 and a top face of the base plate 51.

By inserting papers to be cut into this gap, positioning of a cutting position for the papers along an edge of the paper pressing plate 55 is facilitated. After the cutting position for the papers is matched, the movable member 61 rotates counterclockwise around the pin P1. At this time, both ends of the rail 52 moves to the left side in FIG. 17 by means of the pins P2, P3 movable through the guide hole 57, lowering down.

With a vertical movement of the rail 52, the rail 52 moves horizontally between a condition of (IV) and a condition of (V). At this time, the rail 52 moves horizontally while the front end of the pressing pin 56 provided on the rail 52 rubs the top face of the paper pressing plate 55 with a pressure, because the rail 52 and the paper pressing plate 55 are separated.

Horizontal movement of the paper pressing plate 55 is restricted by the fixing member 62 and the supporting member 54, so that the paper pressing plate 55 moves in a vertical direction perpendicular to the base plate 51. When the paper pressing plate 55 comes down, the papers piled on the base plate 51 are held between the paper pressing plate 55 and the base plate 51 with a pressure such that the piled condition of the papers is kept from being destroyed.

According to the paper pressing unit disclosed in the patent document 1, as described above, even if the papers to be cut are piled on the base plate 51 in multiple quantity, the papers can be positioned on a cutting position easily while preventing deflection of the position of the papers to be cut, because the paper pressing plate 55 moves only vertically.

However, when the rail 52 comes down, the rail 52 moves horizontally while coming down. Particularly, in such a case that the rail 52 is lowered by pressing the slider which slides on the rail 52 without rotating the movable member 61, the slider moves horizontally with respect to the papers to be cut because the rail 52 moves horizontally.

Because of the horizontal movement of the slider, there is a fear that the rotary blade equipped on the slider makes contact with the papers to be cut placed on the base plate 51 so that cutting of the papers by the rotary blade may be started carelessly with lowering of the rail 52. At this time, the papers placed on the base plate 51 are not held with pressure at a final cutting position by the paper pressing plate 55 and consequently, there occurs a deflection in cutting position with start of the cutting by the cutting blade.

### SUMMARY OF THE INVENITON

The present invention intends to solve the above problems and provide a paper cutter having paper pressing function in a securely stable and excellent condition and in which cutting of papers to be cut is not started with a rotary blade mounted on a slider even if the rail is pressed and descended via a slider.

According to a main aspect of the invention, there is provided a paper cutter including: a paper pressing plate for holding papers to be cut placed on a base plate with a pressure; a pair of supporting bodies erected on the base plate; a rail whose both ends are supported by the supporting bodies such that the ends are capable of moving vertically; a slider capable of sliding freely along the rail; and a cutting blade mounted on the slider, being characterized mainly in that first guide holes extending vertically with respect to a base plate surface are formed in the supporting bodies, respectively; the paper pressing plate is mounted on the rail through a spring urged toward a side of the base plate; the rail is urged by a spring forth in a direction leaving the base plate surface; an interlocking member is disposed between the paper pressing plate and the rail, second guide holes are formed in a same direction in both ends of the interlocking member, respectively, and each of the second guide holes has inclined guide faces and parallel guide faces continuous from bottom ends of the inclined guide faces and parallel to the base plate surface; and the rail is supported such that it is capable of approaching/leaving the base plate surface with parallel condition between the rail and the base plate surface maintained, via the linking pins inserted into the first guide holes and the second guide holes.

Preferably, holding means is attached to one of the pair of the supporting bodies such that it is capable of pivoting, a transmission mechanism for converting a rotary motion to a linear motion is formed between the holding means and the interlocking member disposed on the one of the supporting bodies, and the rail is held at a position in which the paper pressing plate is pressed and a position in which the paper pressing plate is released by a rotation of the holding means.

Further preferably, as a transmission mechanism for converting a rotary motion to a linear motion, a rack-and-pinion mechanism or a transmission mechanism comprising a rotation lever and an engagement groove which engages with the lever is used.

In addition, it is preferable that an operation lever which moves linearly is disposed at the one of the pair of the supporting bodies; the operation lever has a contact piece urged elastically toward a side of the interlocking member; and by actuating the operation lever by an engagement between the contact piece and the interlocking member, the interlocking member is moved linearly so as to hold the rail at a position in which the paper pressing plate is pressed and at a position in which the paper pressing plate is released, respectively.

Preferably, at least one guide wing for guiding an insertion of papers to be cut between the paper pressing plate and the base plate is formed on the paper pressing plate such that the guide wing extends parallel to the base plate surface.

Further, it is preferable that a restricting piece for restricting a side edge of the papers to be cut is disposed on the base plate and a specifying groove for specifying a maximum quantity of the papers which can be inserted between the paper pressing plate and the base plate is formed in the restricting piece.

In the paper cutter of the invention, the rail and paper pressing plate can be moved in a vertical direction with respect to the base plate surface while always maintaining a parallel condition with respect to the base plate surface. Additionally, because the rail moves in the vertical direction with respect to the base plate surface along the first guide holes formed in the supporting bodies, the first guide holes are capable of restricting the rail's movement in a direction parallel to the base plate surface.

Further, the second guide holes are formed in the same direction on both ends of the interlocking member and both ends of the rail are supported by linking pins inserted into the second guide holes and the first guide holes, the first guide holes formed in the supporting bodies. As a result, when the interlocking member moves in the direction parallel to the base plate surface, the rail can be moved in the vertical direction with respect to the base plate surface while always keeping a parallel condition to the base plate surface.

By rotating the holding means mounted on the supporting body such that it is capable of pivoting, the interlocking member can be moved in the parallel direction with respect to the base plate surface, thereby capable of holding the position the rail has been moved. Further, also by pressing the rail or the slider capable of sliding along the rail, the rail can be moved in the vertical direction along the first guide hole and the interlocking member can be moved in a parallel direction with respect to the base plate surface.

Further, the third guide hole is formed in the supporting body along a direction parallel to the moving direction of the interlocking member and by reciprocating the operation lever along the third guide hole, the interlocking member engaged with the operation lever can be moved in the parallel direction with respect to the base plate surface. Further, the operation lever enables to hold a position in which the rail has been moved.

A substantially equal contact force over an entire length in the length direction of the paper pressing plate can be applied to papers to be cut securely by pressing an arbitrary position of the slider or the rail with the hand or the fingers, rotating the holding means, or sliding the operation lever. As a consequence, pressing force to the base plate by the paper pressing plate is prevented from being applied to any particular side so as to prevent the papers to be cut from deflecting from its cutting position. Thus, one or more papers can be held at an accurate cutting position and can always be cut with an accurate dimension.

When the rail is descended to the side of the base plate surface, the slider also can be descended without changing a relative position to the rail. Thus, it is possible to prevent the papers to be cut from being cut carelessly by the cutting blade mounted on the slider when the rail descends.

Further, when an end portion of the rail is pressed down via the slider, it is possible to prevent the other end of the paper pressing plate from floating up or the slider from moving in the direction parallel to the base plate surface securely. Additionally, the papers to be cut can be held with pressure on the other end of the paper pressing plate as well with a sufficient pressing force. As a result, the papers to be cut placed on the base plate can be held along the length direction of the paper pressing plate with a substantially equal contact force.

When the rail is descended by rotating the holding means or sliding the operation lever, the rail can be held at a position in which the paper pressing plate is pressed by moving the linking pin to the side of the parallel guide face in the second guide hole. At this time, the paper pressing plate is kept pressed against the base plate surface by a spring disposed between the paper pressing plate and the rail. When papers to be cut are mounted on the base plate surface, the papers can be held at a cutting position with a pressure by the paper pressing plate. As a result, even if the paper cutter is used with its base plate tilted, the papers can be cut accurately.

The papers to be cut on the base plate can be cut accurately by sliding the slider having the cutting blade along the rail from this condition. As the cutting blade, it is permissible to use a rotary blade or a fixed blade having a linear or curved warpage.

When the holding means is rotated in a direction opposite to the descending direction of the rail or the operation lever is slid, the rail ascends along the first guide holes by a spring force which urges it in a direction of leaving the base plate surface. The paper pressing plate ascends together with the rail so that a gap in which the papers can be inserted is formed between the paper pressing plate and the base plate surface. At this time, the rail is held at a position in which the pressing to the paper pressing plate is released.

As the transmission mechanism for moving the interlocking member linearly by rotating the holding means, it is permissible to use a rack-and-pinion mechanism in which a pinion tooth is constructed on a side of the holding means and a rack is formed on a side of the interlocking member. Further, a transmission mechanism, which converts rotary motion to linear motion, may be formed by disposing the rotation lever on the side of the holding means and an engagement groove which engages with the rotation lever on the side of the interlocking member.

Alternatively, another transmission mechanism for converting the rotary motion to the liner motion may be formed by disposing an extension spring for pulling the interlocking member to the side of the supporting body on the side of the supporting body provided with no holding means and then disposing a tension mechanism comprising a wire and a pulley for pulling the interlocking member by rotating the holding means on the side of the supporting body on which the holding means is provided such that it is capable of pivoting. Beside these mechanisms, it is permissible to use a conventionally known transmission mechanism, which converts rotary motion to linear motion, appropriately.

According to the invention, the guide wing capable of guiding papers to be inserted between the paper pressing plate and the base plate can be formed on the paper pressing plate. A curl portion, an inclined face or the like may be formed on the front end of the guide wing. In this way, the guide wing may be constructed to expand in a direction of leaving the base plate gradually to facilitate the insertion of the papers to be cut.

According to the invention, the specifying groove for specifying the maximum quantity of papers which can be inserted between the paper pressing plate and the base plate can be formed in the restricting piece for restricting the side edge of the papers to be cut. When inserting multiple papers to be cut into a gap between the paper pressing plate and the base plate, whether or not it is a quantity of papers, which can be inserted, can be verified by inserting the multiple papers into the specifying groove preliminarily.

If the multiple quantity of the papers can be inserted into the specifying groove, the same multiple papers can be inserted into the gap between the paper pressing plate and the base plate easily. As a consequence, the papers are protected from being pushed and inserted unreasonably into the gap between the paper pressing plate and the base plate in a folded condition. By inserting papers less than a quantity specified by the specifying groove, the papers can always be cut in a quantity suitable for cutting by the paper cutter.

As for the quantity of papers which can be cut with the paper cutter of the invention, not only multiple papers piled up but also even a single paper can be held with a pressure substantially equally between the paper pressing plate and the base plate.

### BRIEF DESCRIPTION OF THE DRAWINGS

FIG. 1 is a perspective view of an entire paper cutter of the invention;

FIG. 2 is a sectional view taken along the line II-II of FIG. 1, showing a major portion of a paper cutter according to a first embodiment of the invention, when holding means is open;

FIG. 3 is a sectional view of the major portion of the paper cutter when the holding means is closed;

FIG. 4 is a side view of an interlocking member in the major portion of the paper cutter.

FIG. 5 is a partially broken perspective view of a cam member in the major portion of the paper cutter;

FIG. 6 is a sectional view taken along the line VI-VI of FIG. 1, showing a major portion of a paper cutter according to a second embodiment of the invention, when holding means is open;

FIG. 7 is a sectional view of the major portion of the paper cutter when the holding means is closed;

FIG. 8 is a side view of an interlocking member in the major portion of the paper cutter;

FIG. 9 is a partially broken perspective view of a cam member in the major portion of the paper cutter;

FIG. 10 is a side view of a paper cutter of the invention when holding means is open;

FIG. 11 is a side view of the paper cutter of the invention when the holding means is closed;

FIG. 12 is a sectional view of a paper cutter according to a third embodiment, when a rail is lowered;

FIG. 13 is a sectional view of the paper cutter when the rail is raised;

FIG. 14 is a sectional view of a paper cutter according to a fourth embodiment, when a rail is raised;

FIG. 15 is a sectional view of the paper cutter when the rail is lowered;

FIG. 16 is a sectional view of the paper cutter in a condition that the rail is lowered by pressing manually;

FIG. 17 is a sectional view of a major portion of a conventional paper cutter, showing an operation condition of a movable member; and

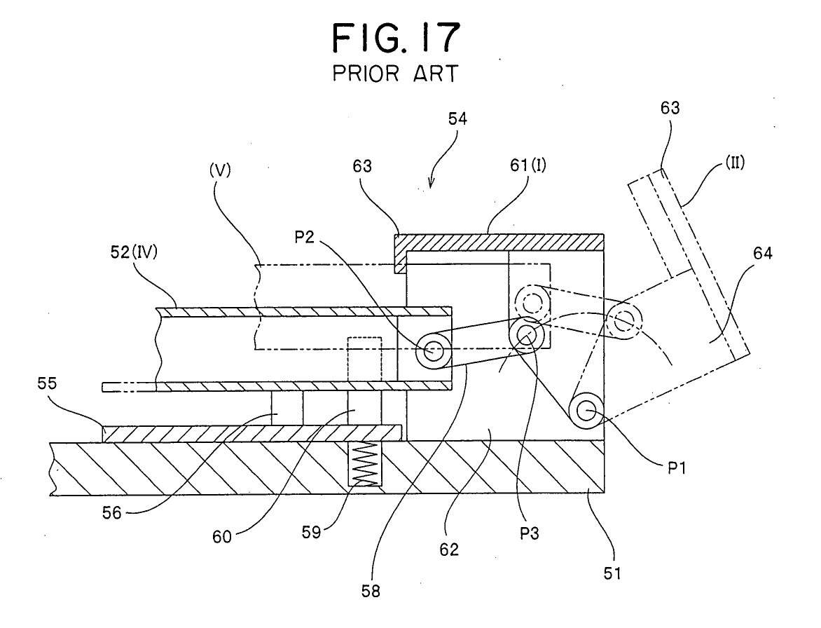

FIG. 18 is a longitudinal sectional view of the major portion of the conventional paper cutter, showing a configuration of a supporting member.

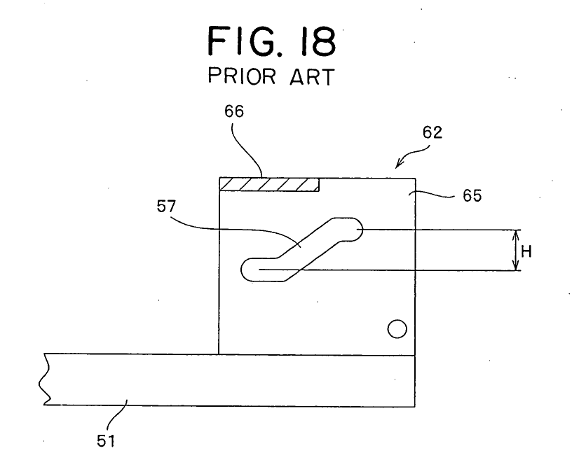

### DESCRIPTION OF THE PREFERRED EMBODIMENTS

The preferred embodiments of the present invention will be explained specifically with reference to the accompanying drawings. As for the configuration of the paper cutter of the invention, even a configuration and an arrangement other than those described below may be adopted as a paper cutter of the invention as long as the object of the invention can be achieved. Therefore, the present invention is not restricted to the embodiments described below and may be modified in various ways.

### First Embodiment

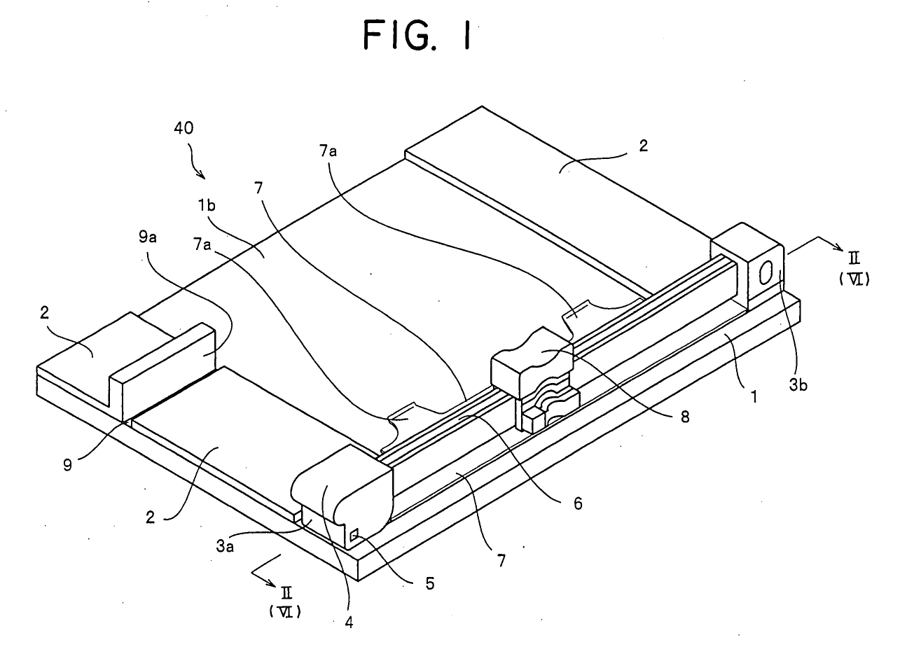

Like a conventionally used paper cutter, a paper cutter shown in FIG. 1 comprises a rectangular base plate 1 having a base plate surface 1b on which papers to be cut are placed; a paper pressing plate 7 for positioning the papers on the base plate surface 1b of the base plate 1 and holding with a pressure; a rail 6 supported such that it is capable of contacting/leaving the base plate surface 1b; and a slider 8 which moves along the rail 6 and has a cutting blade for cutting the papers to a predetermined size. A restricting piece 2 for restricting the edge of the papers to be cut is provided on each of right and left ends of the base plate surface 1b.

A pad (not shown) made of rubber material having a high friction coefficient or of other material is fixed integrally to the bottom face of the paper pressing plate 7, the bottom face making contact with the base plate surface 1b, by appropriate fixing means so as to hold the papers to be cut at a predetermined position securely.

A narrow fitting concave portion is provided linearly in the base plate surface 1b adjacent to the pad, such that the concave portion extends from one side end to another side end in the length direction of the base plate 1. A narrow blade receiving plate made of hard rubber material or the like is fitted to the fitting concave portion and the installation portion of the fitting concave portion corresponds to a cutting position of a rotary blade (not shown) mounted on the slider 8.

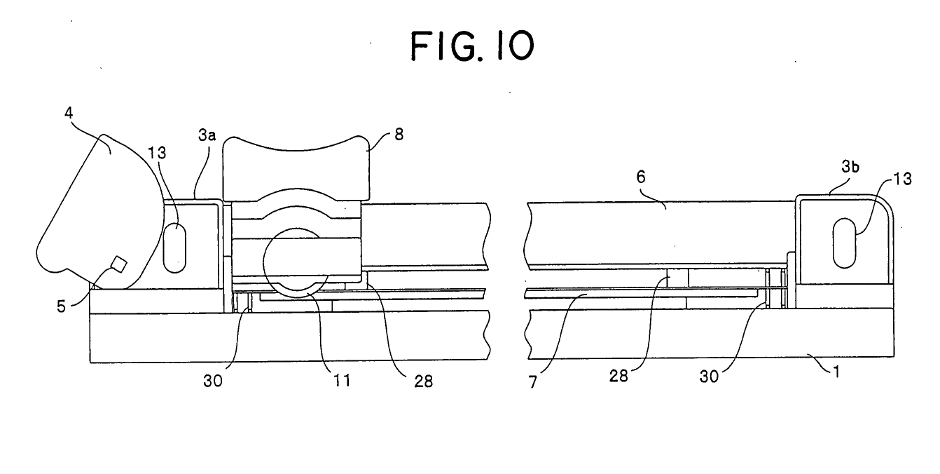

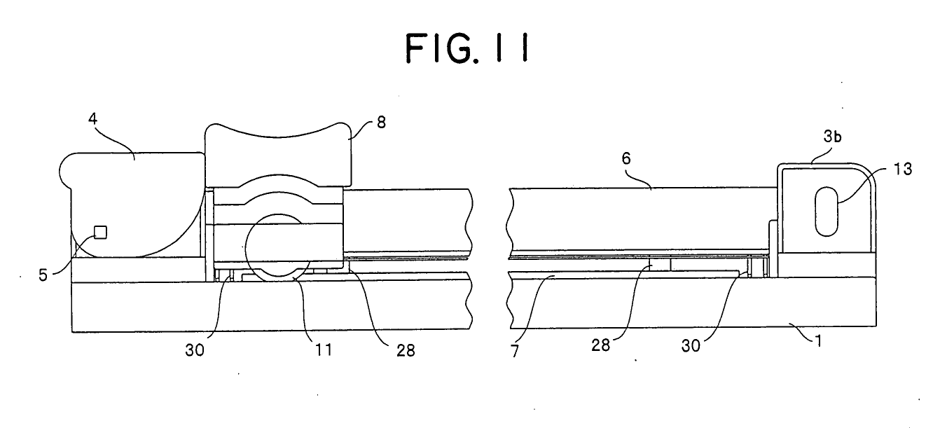

Although, as the cutting blade, an example using a rotary blade will be explained, the present invention is not restricted to the rotary blade and it is permissible to use a linear fixing blade or a curved fixing blade having a curvature. In the first embodiment, the slider 8 supports a rotary blade (see reference numeral 11 of FIGS. 10, 11) such that the blade is capable of rotating freely.

According to the invention, both ends of the rail 6 are supported by supporting bodies 3a, 3b, differently from the paper cutter used conventionally. The rail 6 is restricted from moving in a direction parallel to the base plate surface 1b and supported such that it is capable of moving in a direction perpendicular to the base plate surface 1b. Holding means 4 for moving the rail 6 in the direction perpendicular to the base plate surface 1b is disposed on the supporting body 3a.

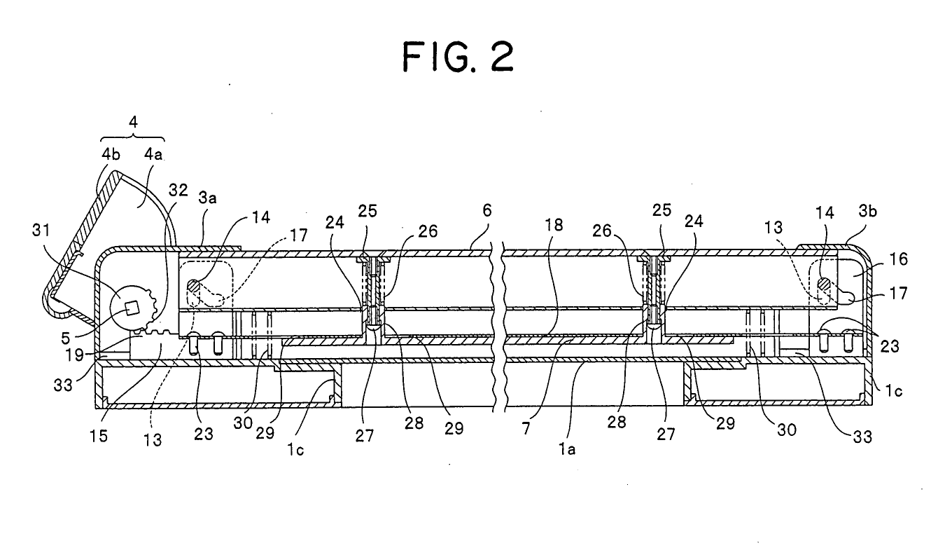

Further, differently from the conventionally used paper cutter, the paper pressing plate 7 is supported via paper pressing spring (see reference numeral 26 in FIG. 2), which is provided between the paper pressing plate 7 and the rail 6, so that the paper pressing plate is capable of moving in the same way as the rail 6 when the rail 6 moves. Further, at least one guide wing 7a is formed integrally on a paper insertion side of the paper pressing plate 7 and the front end portion of the guide wing 7a is expanded in a direction leaving the base plate surface 1b gradually in order to facilitate insertion of papers to be cut.

An upward curled shape or an inclination face, which is inclined such that it rises toward the front end portion of the guide wing 7a, is formed at the front end portion of the guide wing 7a. As a consequence, a multiplicity of papers to be cut can be inserted into a gap between the paper pressing plate 7 and the base plate surface 1b and further, an insertion condition can be recognized easily. Particularly by forming the paper pressing plate 7 with transparent or translucent material, the insertion condition can be recognized easily.

Additionally, differently from the paper cutter used conventionally, a specifying groove 9 having a gap substantially equal to the gap between the paper pressing plate 7 and the base plate surface 1b and a guide wall 9a provided by extending one face of the specifying groove 9 are formed on the restricting piece 2. It is possible to verify a quantity of papers to be inserted by inserting them into the specifying groove 9 before inserting the multiple papers into the gap between the paper pressing plate 7 and the base plate surface 1b. If the papers can be inserted into the specifying groove 9, it is possible to confirm preliminarily that the papers of the same quantity can be inserted into the gap between the paper pressing plate 7 and the base plate surface 1b easily.

The guide wall 9a functions as a guide face when multiple papers are inserted into the specifying groove and further prevents the multiple papers inserted into the specifying groove 9 from falling down.

In the meantime, FIG. 1 does not indicate a movable restricting piece for restricting the rear end portion of the papers to be cut, a guide groove for guiding the restricting piece such that it slides, and other members. However, provision of the movable restricting piece and marking of specifying lines on the base plate surface 1b are one of various compositions provided on the conventional paper cutter and provision of each of those compositions may be adopted appropriately as required.

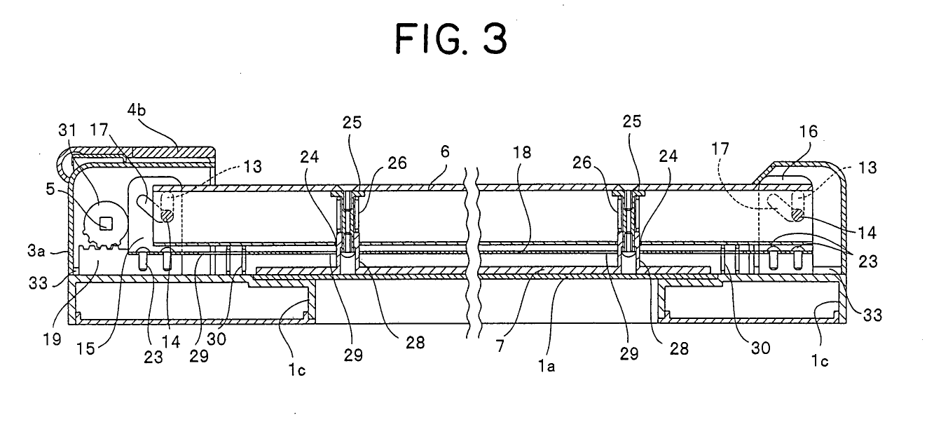

Next, the actuation mechanism of the rail 6 and the paper pressing plate 7 will be explained with reference to FIGS. 2-5. FIGS. 2 and 3 are sectional views taken along the line II-II shown with the slider 8 omitted, and FIG. 2 shows a condition in which the holding means 4 is rotated with a handle shaft 5. As shown in FIG. 2, a pair of the supporting bodies 3a, 3b are fixed on the base plate surface 1b and first guide holes 13 extending in a direction perpendicular to the base plate surface 1b are formed in side faces of the supporting bodies 3a, 3b.

Both ends of the rail 6 are supported by the first guide holes 13 via linking pins 14, respectively, such that the rail 6 can move vertically with respect to the base plate surface 1b along the first guide holes 13. Both ends of each linking pin 14 are supported by the rail 6 and the linking pins 14 keep a sliding contact with the inside of the first guide holes 13.

Push-up springs 30 are disposed between the rail 6 and the base plate surface 1b. The rail 6 is urged in the direction of departing from the base plate surface 1b by the push-up springs 30. Movement of the rail 6 in the length direction is restricted by a contact between the linking pins 14 and the first guide holes 13.

The paper pressing plate 7 is disposed between the rail 6 and the base plate surface 1b. A guide pin 25 is fixed to the back side of the rail 6. Guide pipes 28 provided protrudedly on the paper pressing plate 7 are disposed such that the guide pins 25 are capable of sliding as guide faces. Further, the paper pressing springs 26 are disposed between the back side of the rail 6 and the guide pipes 28. The sliding amount of the guide pipe 28 is restricted by a stopper screw 27 engaged with the guide pin 25 and a step portion formed in the inner face of the guide pipe 28.

The paper pressing plate 7 can move in the direction of approaching/leaving the base plate surface 1b independently of the rail 6 by sliding of the guide pipe 28 along the guide pin 25. To slide the guide pipe 28 along the guide pin 25, an opening hole 24 is formed in the rail 6 around the guide pin 25 in order to prevent an interference with the guide pipe 28.

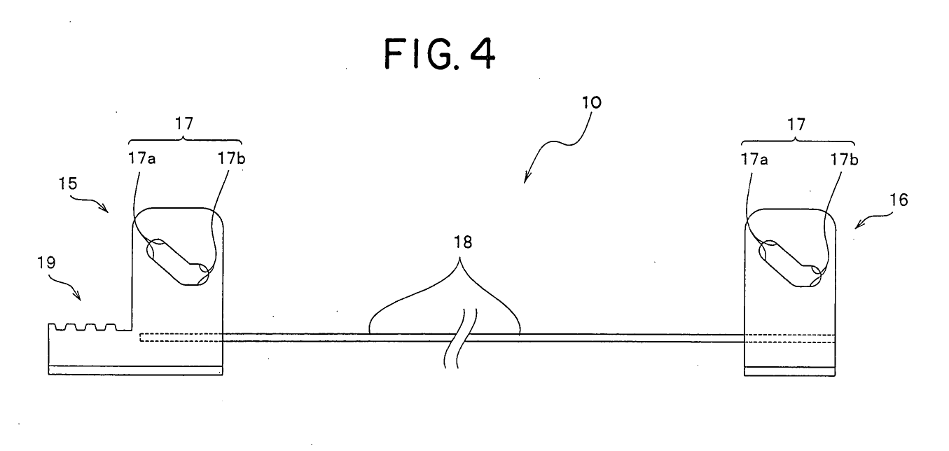

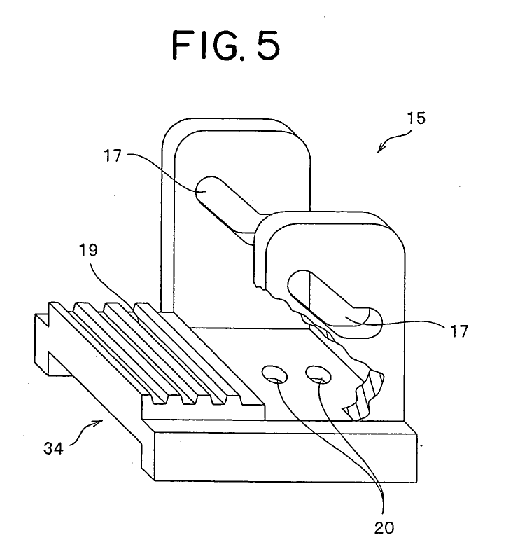

An interlocking member 10 is disposed between the rail 6 and the paper pressing plate 7. The interlocking member 10 shown in FIG. 4 is so constructed that an arm 18 is attached between a pair of cam members 15 and 16. A pair of sidewalls are formed on the respective cam members 15, 16 in order to attach the arm 18. By inserting the end portions of the arm 18 between the pair of side walls and engaging set screws 23 with mounting holes (see reference numeral 20 in FIG. 5) formed in the respective cam members 15, 16, the end portions of the arm 18 can be mounted to the respective cam members 15, 16.

As shown in FIG. 5, second guide holes 17 are formed in the side walls of the respective cam members 15, 16 such that they are directed in the same direction and each of the second guide holes comprises an inclined guide face 17a and a parallel guide face 17b which is continuous to the inclined guide face 17a. The parallel guide face 17b is a guide face parallel to the base plate surface 1b. As shown in FIG. 4, the second guide holes formed in the cam member 15 and the cam member 16 are directed in the same direction.

As shown in FIGS. 2, 3, elongated holes 29 are formed in the length direction of the arm 18. The elongated holes 29 can prevent an interference with the push-up springs 30 which urges the guide pipes 28 and the rail 6 in the pushing-up direction, even if the arm moves in a direction parallel to the base plate surface 1b. Further, a rack portion 19 is formed on the cam member 15 as shown in FIG. 5. Although FIG. 5 shows only a perspective view of the cam member 15, a guide concave portion 34 is formed in the bottom side of each of the cam members 15, 16. The guide concave portion 34 is provided so as to stride over the guide rail 33 formed on the base plate surface 1b within each of the supporting bodies 3a, 3b and capable of sliding with the same guide rail 33 as a guide face.

The linking pins 14 which respectively support both ends of the rail 6 are inserted into the second guide holes 17 in the interlocking member 10 and the first guide holes 13 in the supporting bodies 3a, 3b. As the interlocking member 10 moves in the direction parallel to the base plate surface 1b, the rail 6 can move in a direction vertical to the base plate surface while always maintaining a parallel condition to the base plate surface.

Supporting means 4 for moving the interlocking member 10 in the direction parallel to the base plate surface 1b is supported by the supporting body 3a such that it is capable of rotating freely. The holding means 4 comprises a handle 4a and a handle cover 4b, and a handle shaft 5 is mounted on the handle cover 4b such that it is incapable of rotating. A pinion 31, which engages with the rack portion 19 of the cam member 15, is disposed on the handle shaft 5 such that a rotation of the pinion 31 is restricted. The handle shaft 5 is supported by the supporting body 3a via a bearing or the like, so that the holding means 4 is capable of rotating around the handle shaft 5 with respect to the supporting body 3a.

Rotary motion of the holding means 4 can be converted to linear motion of the interlocking member 10 by the rack portion 19 and pinion 31.

Although FIGS. 2, 3 show an example that the base plate 1 is constituted of a pair of leg portions 1c and a base member 1a stretched between the pair of leg portions 1c, as for the configuration of the base plate 1, it is permissible to constitute the base and leg portion integrally like the base plate used in the second embodiment. In FIGS. 2, 3, the base plate surface 1b is formed of the surface of the leg portion 1c and the base member.

Next, an operation of moving the rail 6 and the paper pressing plate 7 in the direction perpendicular to the base plate surface 1b by the rotation of the holding means 4 will be explained with reference to FIGS. 2, 3, and 10, 11.

FIGS. 3, 11 show a condition in which no papers to be cut are placed on the base plate 1. In this condition, part of the tip of the rotary blade 11 mounted rotatably on the slider 8 is kept inserted into a fitting concave portion (not shown) formed in the base plate 1.

By raising the handle 4a from a condition of FIGS. 3, 11 and rotating the holding means 4 in the counterclockwise direction in FIG. 3 with respect to the supporting body 3a, a condition shown in FIGS. 2, 10 is obtained. At this time, the handle shaft 5 rotates in the counterclockwise direction with a rotation of the handle 4a so as to rotate the pinion 31 on the handle shaft 5 in the counterclockwise direction. With the rotation of the pinion 31, the cam member 15 having the rack portion 19 engaging with the pinion 31 moves in the right direction in FIG. 2 along the guide rail 33. With the movement of the cam member 15, the other cam member 16 attached to the other end of the arm 18 moves in the right direction of FIG. 2 along the guide rail 33.

At this time, the linking pin 14 making a sliding contact with the parallel guide faces 17b (see FIG. 4) of the second guide hole 17 comes from the parallel guide faces 17b into a sliding contact with the inclined guide faces 17a with the movement of the cam members 15, 16. If the linking pin 14 comes into a sliding contact with the inclined guide faces 17a, the rail 6 is raised in the direction leaving the base plate surface 1b along the first guide hole 13 by an urging force of the push-up spring 30.

If the rail 6 moves by the push-up springs 30, the handle 4a rotates in the counterclockwise direction and the pinion 31 gets out of engagement with the rack portion 19 in the handle 4a, the interlocking member 10 moves in the right direction in FIG. 3 along the guide rail 33 by a pressing force 17a by the linking pin 14 to the inclined guide face 17a. As a consequence, the rail 6 can rise in the vertical direction leaving the base plate surface while always maintaining a parallel condition with respect to the base plate surface.

With the movement of the rail 6, the paper pressing plate 7 rises in the vertical direction of leaving the base plate surface 1b while always maintaining a parallel condition to the base plate surface. When an interval between the rail 6 and the base plate surface 1b is maximized as shown in FIG. 2, that is, the linking pin 14 reaches the top end portion of the first guide hole 13 or the second guide hole 17, the rise of the rail 6 stops so that the rail 6 is maintained at a position in which pressing to the paper pressing plate 7 is released.

At this time, the side face of the paper cutter 40 turns to the condition shown in FIG. 10. The holding means 4 is rotated in the counterclockwise direction in FIG. 10 from the supporting body 3a. The slider 8 mounted rotatably on the rotary blade 11 may be kept near the supporting body 3a. Although the slider 8 may be located at an arbitrary position on the rail 6, it is desirable to position the slider 8 at a position in which the rotary blade 11 makes no contact with the papers to be cut when the rail 6 is descended after the papers 41 are inserted.

Next, the papers to be cut 41 are inserted between the base plate surface 1b and the paper pressing plate 7 as shown in FIG. 10 and after a cutting position of the inserted papers is determined, the handle 4a is rotated in the clockwise direction in FIG. 2. If the handle 4a is rotated in the clockwise direction, the pinion 31 is rotated in the clockwise direction so that it engages with the rack portion 19 of the cam member 15 and then, the cam member 15 moves in the left direction in FIG. 2 along the guide rail 33. When the cam member 15 moves, the other cam member 16 is moved in the left direction in FIG. 2 along the guide rail 33 via the arm 18, so as to move the interlocking member 10 in the left direction in FIG. 2.

With the movement of the cam members 15, 16 in the left direction, the link pin 14 making a sliding contact with the inclined guide face 17a of the second guide hole 17 descends along the first guide hole 13 with guided by the inclined guide face 17a. With the descent of the linking pin 14, the rail 6 descends in a direction approaching the base plate surface 1b while always maintaining a parallel condition to the base plate surface 1b.

The paper pressing plate 7 descends with the rail 6 and when the bottom face of the paper pressing plate 7 comes into contact with the papers to be cut, the paper pressing plate 7 maintains a height in which it makes contact with the papers while compressing the pressing spring 26. When the linking pin 14 reaches the bottom end of the inclined guide face 17a, the descent of the rail 6 stops. At this time, the urging force corresponding to the interval between the rail 6 and the paper pressing plate 7 acts on the paper pressing plate 7 form the paper pressing spring 26, so that the paper pressing plate 7 keeps the papers to be cut under a pressure by the same urging force.

If the handle 4a is rotated further after the linking pin 14 reaches the bottom end of the inclined guide face 17a, the cam member 15 moves further in the left direction in FIG. 2 with a rotation of the pinion 31 so as to produce a condition shown in FIG. 3. At this time, the linking pin 14 comes into a sliding contact with the parallel guide face 17b thereby preventing the rail 6 from being raised by the urging force by the push-up spring 30. That is, the paper pressing plate 7 is maintained at a position in which it is pressed by the rail 6.

The parallel guide face 17b does not need to always be kept parallel to the base plate surface 1b and the guide face may be tilted more or less as long as a rise of the rail 6 urged by the urging force of the push-up spring 30 can be prevented by the linking pin 14 coming to the parallel guide face 17b. Such a guide face titled more or less is included in the parallel guide face of the invention.

When the rail 6 is descended, the slider 8 maintains a positional relation to the rail 6, the positional relation being before the rail 6 descends. Thus, it is possible to prevent the rotary blade 11 mounted on the slider 8 from cutting the papers to be cut during the descent of the rail.

By moving the slider 8 plural times in the right and left direction depending on the quantity of the papers mounted after those papers are held with a pressure by the paper pressing plate 7, the papers can be cut accurately at a preliminarily determined cutting position. In the above description, an operation of moving the rail 6 vertically by rotating the handle 4a has been explained. The vertical move of the rail 6 may be carried out not only by pressing the rail 6 with the hand or fingers, but also by pressing the slider 8.

### Second Embodiment

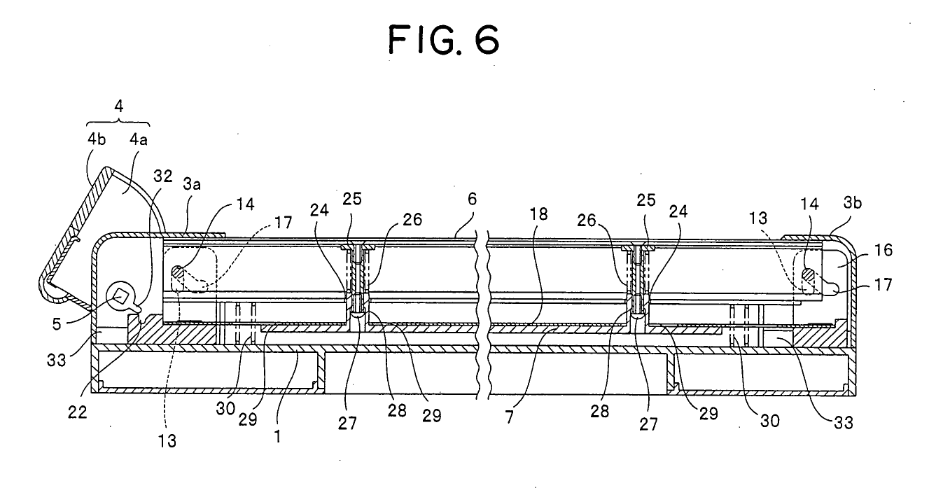

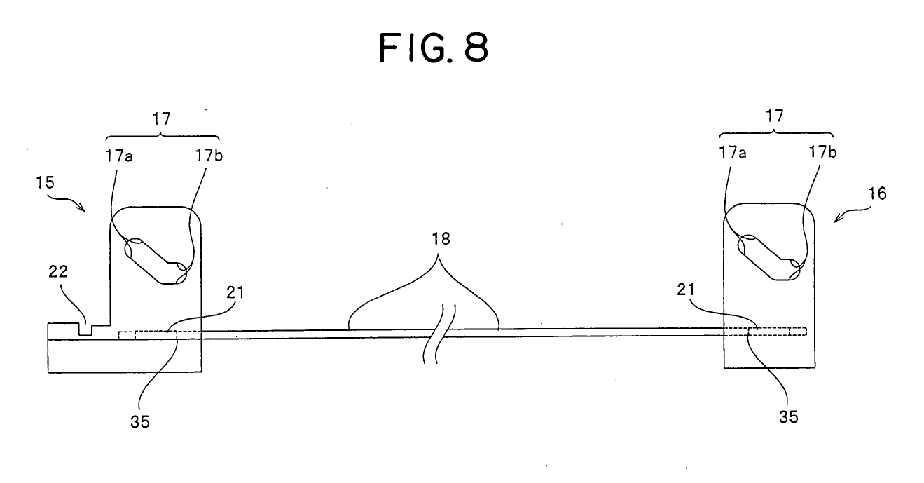

Next, other preferred embodiment of the invention will be explained with reference to FIGS. 6-9. Description of the same composition as the first embodiment in the configuration of the second embodiment is omitted by using the same reference numerals as those used in the first embodiment.

The second embodiment is different from the first embodiment in that a transmission mechanism for converting rotary motion to linear motion by sliding the cam member 15 along the guide rail 33 by rotating the handle 4a is constituted of a rotation lever 32 and an engagement groove 22, which engages with the rotation lever 32. Further, the second embodiment is different from the first embodiment in that as a method for mounting the arm 18 on the cam members 15, 16, an engagement hole 35 formed on a side of the end portion of the arm 18 is engaged with a mounting piece 21 formed on the cam members 15, 16.

As for other configuration, although according to the first embodiment, the base member 1a of the base plate 1 is stretched between a pair of the leg portions 1c, the second embodiment is different from the first embodiment in that the base member and the leg portions are formed integrally. The configuration of the base member and leg portions does not form a major factor of the present invention and it is permissible to adopt various configurations used conventionally.

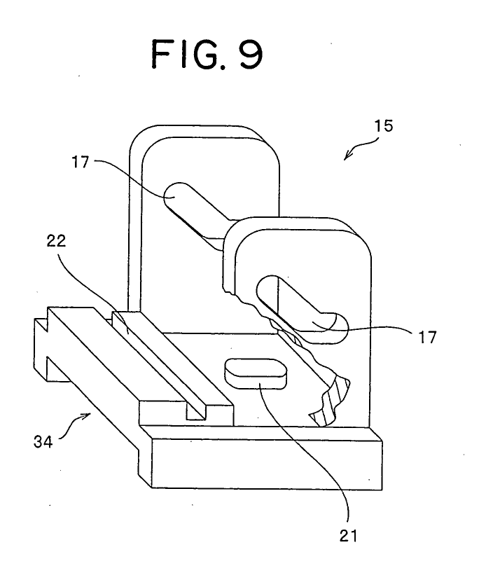

As shown in FIG. 9, the mounting piece 21 has an inverse tapered side face, which prevents the engagement hole 35 in the arm 18 fitted to the mounting piece 21 from slipping out easily. However, the shape of the mounting piece 21 is not restricted to such a configuration having the inverse tapered side face and it is permissible to adopt other configuration as long as it is a combining configuration of the engagement hole 35 and the mounting piece 21, which makes it difficult for the arm 18 to escape from the mounting piece 21. Although not shown, the mounting piece 21 on the cam member 16 has the same configuration as the mounting piece 21 on the cam member 15.

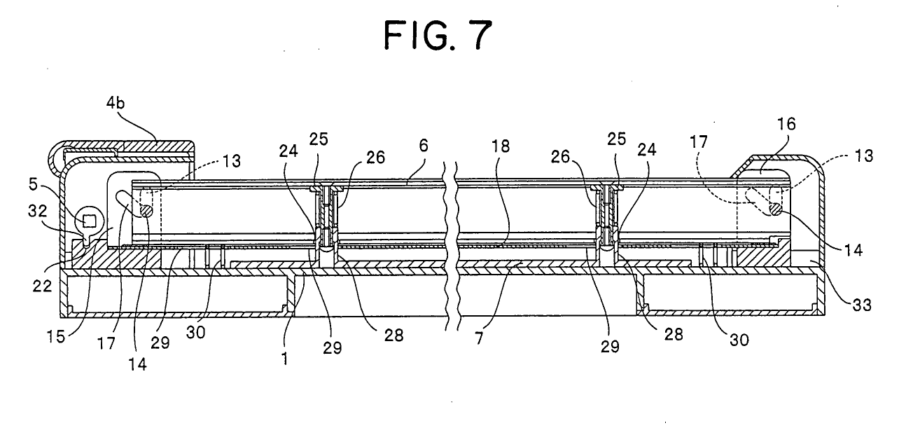

The engagement groove 22, which engages with the rotary lever 32, is formed in the cam member 15. The rotary lever 32 is mounted on a handle shaft 5, rotating together with the handle shaft 5. If the handle 4a is rotated in the clockwise direction around the handle shaft 5 from a condition shown in FIG. 6, the interlocking member 10 moves in the left direction in FIG. 7 such that the linking pin 14 moves from a condition in which it makes contact with the inclined guide face 17a to a condition in which it makes contact with the parallel guide face 17b. As a consequence, the rail 6 may be held at a lower position.

If the handle 4a is rotated in the counterclockwise direction from a condition of FIG. 7, the linking pin 14 moves from the condition in which it makes contact with the parallel guide face 17b to the condition in which it makes contact with the inclined guide face 17a. At this time, the interlocking member 10 raises the linking pin 14 along the inclined guide face 17a by the urging force of the push-up spring 30 which pushes up the rail 6 and the interlocking member 10 moves in the right direction of FIG. 6.

At this time, an engaging condition between the rotary lever 32 and the engagement groove 22 is released, so that the interlocking member 10 moves freely. The engagement groove 22 may be formed over the width direction of the cam member 15 or may be formed in only a portion, which engages with the rotation lever 32.

### Third Embodiment

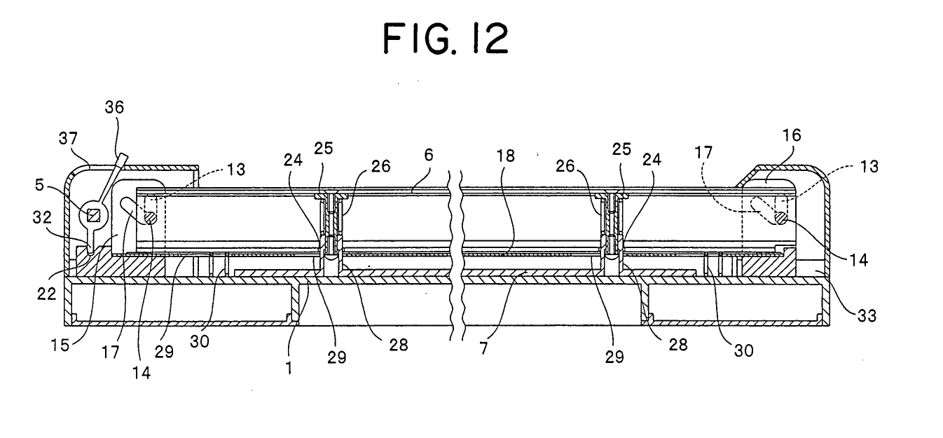

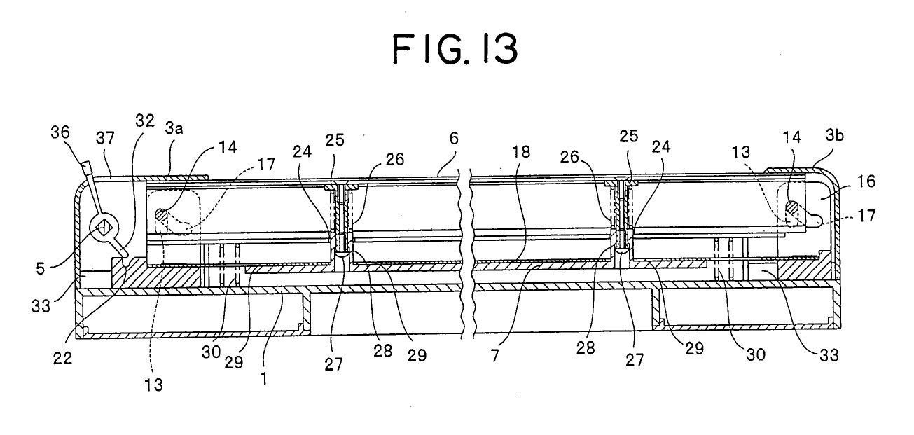

Next, other preferred embodiment of the present invention will be explained with reference to FIGS. 12, 13. Description of the same configuration as the first embodiment and the second embodiment in the configuration of the third embodiment is omitted by using the same reference numerals as used in the first embodiment and the second embodiment.

According to the third embodiment, instead of using the handle 4a as the holding means 4 for rotating the rotation lever 32 in the second embodiment, an operation handle 36 is attached to the rotation lever 32 and this embodiment is different from the second embodiment in that the operation handle 36 is projected from a third guide hole 37 formed in the supporting body 3a.

The third guide hole 37 is formed in the supporting body 3a in a direction parallel to the moving direction of the interlocking member 10. By rotating the operation handle 36 projected from the third guide hole 37 around the handle shaft 5, the interlocking member 10 may be moved in the same manner as when the handle 4a in the second embodiment is rotated.

Further, by rotating the operation handle 36 in the counterclockwise direction from the condition of FIG. 12 like the handle 4a in the second embodiment, the linking pin 14 moves from the condition in which it makes contact with the parallel guide face 17b to the condition in which it makes contact with the inclined guide face 17a. The linking pin 14 rises along the inclined guide face 17a by the urging force of the push-up spring 30, which pushes up the rail 6, so that the interlocking member 10 moves in the right direction so as to obtain the condition of FIG. 13.

At this time, the engaging condition between the rotary lever 32 and the engagement groove 22 is released, so that the interlocking member 10 moves in the right direction freely. If the operation handle 36 is rotated in the clockwise direction from the condition of FIG. 13, the rotation lever 32 engages with the engagement groove 22, so that the interlocking member 10 moves in the left direction of the same Figure with a rotation of the operation handle 36. When the operation handle 36 rotates up to the vicinity of the end portion of the third guide hole 37, the linking pin 14 makes contact with the parallel guide face 17b so as to obtain the condition shown in FIG. 12.

### Fourth Embodiment

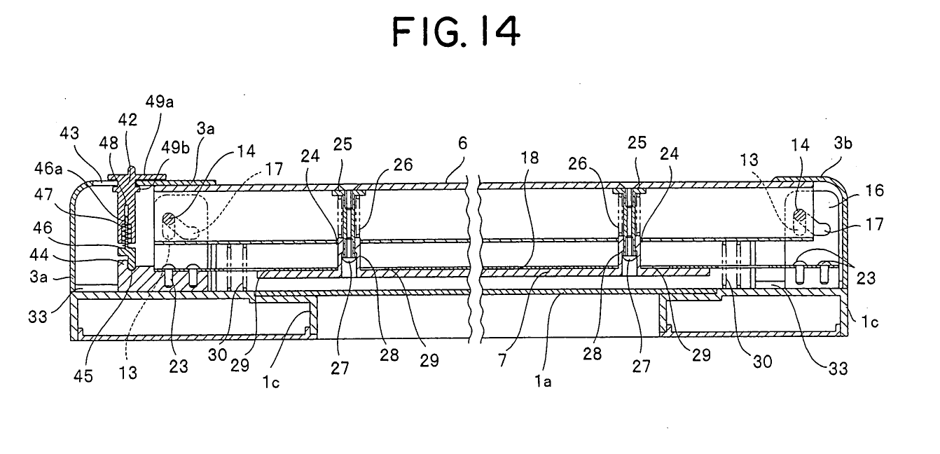

Still other preferred embodiment of the present invention will be explained with reference to FIGS. 14-16. Description of the same configuration as the first embodiment to the third embodiment in the configuration of the fourth embodiment is omitted by using the same reference numerals as those used in the first embodiment to the third embodiment.

The fourth embodiment is different from the first embodiment-third embodiment in that instead of rotating the rotation lever 32, the operation lever 42 is slid linearly along a fourth guide hole 43 formed in the supporting body 3a so that the operation lever 42 can be engaged with an engagement step 44 or an engagement groove 45 in the interlocking member 10 selectively.

A pair of flange portions 49a, 49b are formed on a contact face between the operation lever 42 and the fourth guide hole 43 and the operation lever 42 is kept with not slipping out of the fourth guide hole 43. At least one of the pair of the flange portions 49a, 49b is so constructed as to be detachable from the operation lever 42. The fourth guide hole 43 is formed in the supporting body 3a as a guide hole parallel to the moving direction of the interlocking member 10.

A contact piece 46 is disposed on the side of the cam member 15 of the operation lever 42 and the contact piece 46 is urged to a surface side of the cam member 15 by a spring 47. Further, a guide rod 46a formed on the contact piece 46 is inserted into a guide hole 48 formed in the shaft portion of the operation lever 42 so as to guide a sliding direction of the contact piece 46. An engagement groove 45 is formed in the cam member 15, the engagement groove 45 engages with the engagement step 44 and the contact piece 46.

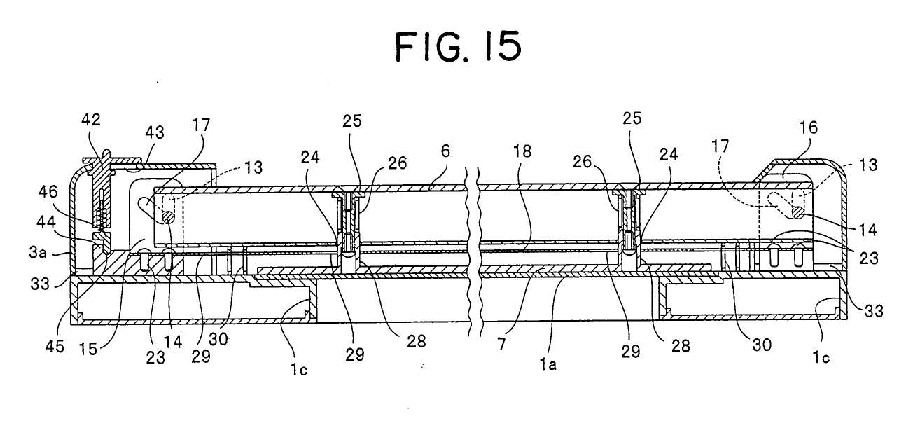

If the operation lever 42 is slid in the left direction from the condition of FIG. 14 of the same Figure along the fourth guide hole 43, the interlocking member 10 moves in the left direction by the engagement between the contact piece 46 and the engagement groove 45 and the engagement step 44. As a consequence, the condition shown in FIG. 15 is produced, so that the rail 6 is moved downward and can be held at a downward position by a contact between the linking pin 14 and the parallel guide face.

If the operation lever 42 is moved in the right direction along the fourth guide hole 43 from the condition of FIG. 15, the contact piece 46 engages with the engagement groove 45 so as to allow the interlocking member to move in the right direction. FIG. 14 shows a condition in which the interlocking member has been moved in the right direction.

By the way, the vertical movement of the rail 6 may be carried out by pressing the rail 6 directly with the hand or the like without using the operation lever 42. At this time, if the rail 6 is pressed from the condition of FIG. 14, the interlocking member 10 tries to move in the left direction in FIG. 14 due to the engagement relation between the linking pin 14 and the second guide face 17. At this time, the contact piece 46 ride over the engagement groove 45 by a moving force of the interlocking member 10b in the left direction, so that the cam member 15 slides with the top face thereof in contact with the contact piece 46.

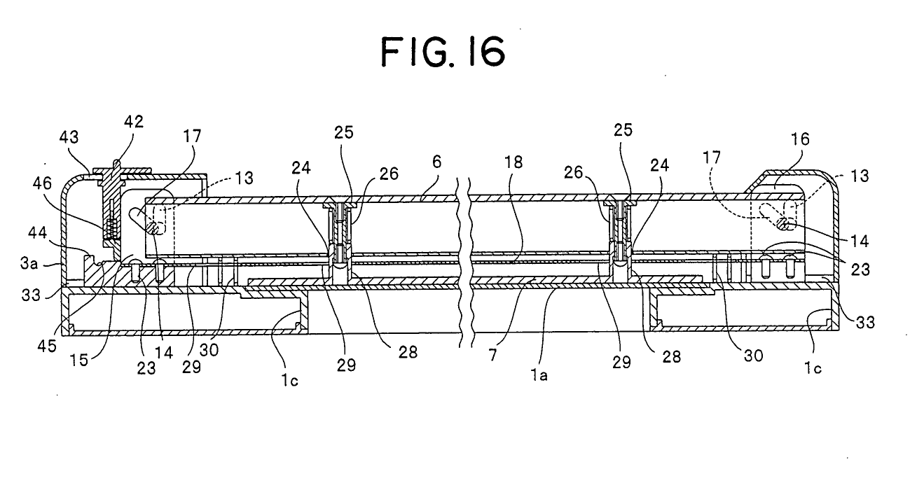

If the rail 6 is pressed up to the downward position, the linking pin 14 moves to the bottom end position of the inclined guide face 17a as shown in FIG. 16 and does not move up to a position in which it makes contact with the parallel guide face 17b. At this time, if the pressing force with respect to the rail 6 is released, the rail 6 and the interlocking member 10b can be automatically restored up to the position shown in FIG. 15 by the urging force of the push-up spring 30.

According to the invention, the movement of the paper pressing plate 7 and the rail 6 may be converted to a simple movement in the vertical direction not interlinking with the movement of the arm 18 of the interlocking member 10. Because the parallel movement with respect to the base plate surface 1b is carried out by the arm 18, deflection of the cutting position for the papers to be cut, which is generated by the parallel movement to the base plate surface 1b can be prevented before it happens. Further, a final cutting position by the paper pressing plate 7 can be recognized very easily.

When the quantity of papers to be cut is small, the papers can be cut only by moving the slider 8 along the rail 6 with pressing the slider 8 and the rail 6 instead of holding the papers with the paper pressing plate 7 by operating the handle 4a, and the operation for cutting can be executed simply.

When the rail 6 is descended by operating the handle 4a, the rail 6 can be held at the descended position. Thus, even if the paper cutter 40 is used in a tilted condition instead of used in a horizontal condition, the papers to be cut can be cut at a final cutting position by the paper pressing plate 7.

If the engagement condition between the rack portion 19 and the pinion 31 is released or engagement between the rotation lever 32 and the engagement groove 22 is released, the rail 6 can be promptly restored to its original position by the urging force of the push-up spring 30. Thus, preparation for a next operation can be executed smoothly.

Because the specifying groove for specifying a maximum quantity of papers which can be inserted between the base plate surface 1b and the paper pressing plate 7 is formed in the restricting piece which restricts the side edges of the papers to be cut, the quantity of papers, which can be cut, can be measured as a step for preparation for arranging the ends of the papers neatly.

Further, because the guide wings for guiding the insertion of the papers are formed on the paper pressing plate and the front end portion of the guide wing is expanded so as to facilitate the insertion of the papers, the papers to be cut can be inserted smoothly and the insertion condition can be recognized at a bright place on the base plate. Further, even wide papers can be inserted easily because a plurality of the guide wings may be formed and further, they can be inserted in a stable condition.

What is claimed is:

1. A paper cutter including: a paper pressing plate for holding papers to be cut placed on a base plate with a pressure; a pair of supporting bodies erected on the base plate; a rail whose both ends are supported by the supporting bodies such that the ends are capable of moving vertically; a slider capable of sliding freely along the rail; and a cutting blade mounted on the slider, wherein
first guide holes extending vertically with respect to a base plate surface are formed in the supporting bodies, respectively,
the paper pressing plate is mounted on the rail through a spring urged toward a side of the base plate,
the rail is urged by a spring force in a direction leaving the base plate surface,
an interlocking member is disposed between the paper pressing plate and the rail, second guide holes are formed in a same direction in both ends of the interlocking member, respectively, and each of the second guide hole has inclined guide faces and parallel guide faces continuous from bottom ends of the inclined guide faces and parallel to the base plate surface, and
the rail is supported such that it is capable of approaching/leaving the base plate surface with a parallel condition between the rail and the base plate surface maintained, via the linking pins inserted into the first guide holes and the second guide holes.

2. The paper cutter according to claim 1, wherein holding means is attached to one of the pair of the supporting bodies such that it is capable of pivoting, a transmission mechanism for converting a rotary motion to a linear motion is formed between the holding means and the interlocking member disposed on the one of the supporting bodies, and the rail is held at a position in which the paper pressing plate is pressed and a position in which the paper pressing plate is released by a rotation of the holding means.

3. The paper cutter according to claim 2, wherein the transmission mechanism is a rack-and-pinion mechanism.

4. The paper cutter according to claim 2, wherein the transmission mechanism is a transmission mechanism comprising a rotation lever and an engagement groove which engages with the lever.

5. The paper cutter according to claim 1, wherein an operation lever which moves linearly is disposed at one of the pair of the supporting bodies; the operation lever comprises a contact piece urged elastically toward a side of the interlocking member; and by actuating the operation lever by an engagement between the contact piece and the interlocking member, the interlocking member is moved linearly so as to hold the rail at a position in which the paper pressing plate is pressed and at a position in which the paper pressing plate is released, respectively.

6. The paper cutter according to any one of claims 1 to 5, wherein at least one guide wing for guiding an insertion of papers to be cut between the paper pressing plate and the base plate is formed on the paper pressing plate such that the guide wing extends parallel to the base plate surface.

7. The paper cutter according to any one of claims 1 to 5, wherein a restricting piece for restricting a side edge of the papers to be cut is disposed on the base plate and a specifying groove for specifying a maximum quantity of the papers which can be inserted between the paper pressing plate and the base plate is formed in the restricting piece.

8. The paper cutter according to claim 6, wherein a restricting piece for restricting a side edge of the papers to be cut is disposed on the base plate and a specifying groove for specifying a maximum quantity of the papers which can be inserted between the paper pressing plate and the base plate is formed in the restricting piece.
